(19) United States
(12) Patent Application Publication
(10) Pub. No.: US 2005/0023729 A1
(43) Pub. Date: Feb. 3, 2005

(54) Formation of wide paint film parts

(76) Inventors: Leslie E. Smith, Lapeer, MI (US); John C. Montagna, Metamora, MI (US)

Correspondence Address: Christopher John Rudy, Ste. 8, 209 Huron Ave., Port Huron, MI, 48060, US

(21) Appl. No.: 10/743,936

(22) Filed: Dec. 23, 2003

Related U.S. Application Data
(60) Provisional application No. 60/491,435, filed on Jul. 31, 2003.

(51) Int. Cl. B29C 55/04; B29C 55/06; B29C 55/08

(52) U.S. Cl. 264/288.4; 264/290.2; 425/145; 425/391

(57) ABSTRACT

Apparatus for forming wide paint film parts includes a frame; and, attached to the frame, at least two paint film stock grasping members, which generally oppose one another, which can grasp deformable paint film stock, at least one of which can be moved apart from the other while the stock is grasped. The frame may have lateral support members in a rectangular or square arrangement, and the grasping members may include orthogonal, oblique and corner types. The apparatus can be electrically controlled and/or pneumatically actuated. Wide paint film parts may be formed by providing the apparatus; providing a deformable paint film stock; grasping the stock on generally opposing sides by at least two paint film stock grasping members; and, moving, while the stock is so grasped, the at least one of the two paint film stock grasping members apart from the other so as to draw or stretch the stock. A drawn or stretched paint film stock part precursor or a formed wide paint film stock part can result.

This claims benefit under 35 USC 119(e) of provisional patent application No. 60/491,435 filed on Jul. 31, 2003 A.D., the whole specification of which is incorporated herein by reference.

### FIELD OF THE INVENTION

The present invention concerns an apparatus and a method for formation of wide paint film parts. Such parts are of concern here also, as a wide part precursor, and a wide part itself.

### BACKGROUND TO THE INVENTION

Various articles of manufacture are made with paint film technology. In such technology, a deformable base, for example, of a thermoformable plastic, has a paint film laminated thereon, and such a laminated composition may be obtained commercially or made on site. The laminated composition is formed into a part, for example, through pressure or vacuum molding. Thus, for example, sport utility vehicle running boards can be made.

However, the paint film industry is currently limited with respect to sheet width. The widest width known to be available approaches approximately sixty, for example, being fifty-eight, inches. This limitation occurs for various reasons, among which is the greater expense that would be entailed to make paint film stock of widths greater than available since, among other things, the application of paint film to form the stock is carried out by a gravure process. As a result, many wide products, for example, tonneau covers, cannot be made with prior paint film technology.

It would be desirable to ameliorate or overcome this.

### DISCLOSURE OF THE INVENTION

In general, the present invention provides, in one aspect, an apparatus for formation of wide paint film parts, which comprises a frame; and, attached to the frame, at least two paint film stock grasping members, which generally oppose one another, which can grasp deformable paint film stock, at least one of which can be moved apart from the other while the stock is grasped. Such members may be grasper-retractors. Provided in another aspect is a method for formation of wide paint film parts, which comprises providing the apparatus for formation of wide paint film parts; providing a deformable paint film stock; grasping the stock on generally opposing sides by at least two paint film stock grasping members; and, while the stock is so grasped, moving the at least one of the two paint film stock grasping members apart from the other so as to draw or stretch the stock. Additional aspects of the invention include a drawn or stretched paint film stock part precursor, and a formed wide paint film stock part.

The invention is useful in plastic and paint film technology.

Significantly, by the invention, paint film technology is advanced in kind by making provision for wide paint film parts. In particular, paint film stock part precursors and parts can be made wider than available paint film stock. Thus, the paint film industry is not necessarily limited with respect to sheet width. And so, many wide products, for example, tonneau covers, can be made with the instant paint film technology. In turn, hazards associated with spray or electrostatic painting of such wide parts can be avoided, and manufacturing costs of such wide parts can be reduced. Numerous further advantages attend the invention.

The drawings form part of the specification hereof. With respect to the drawings, which are not necessarily drawn to scale, the following is briefly noted:

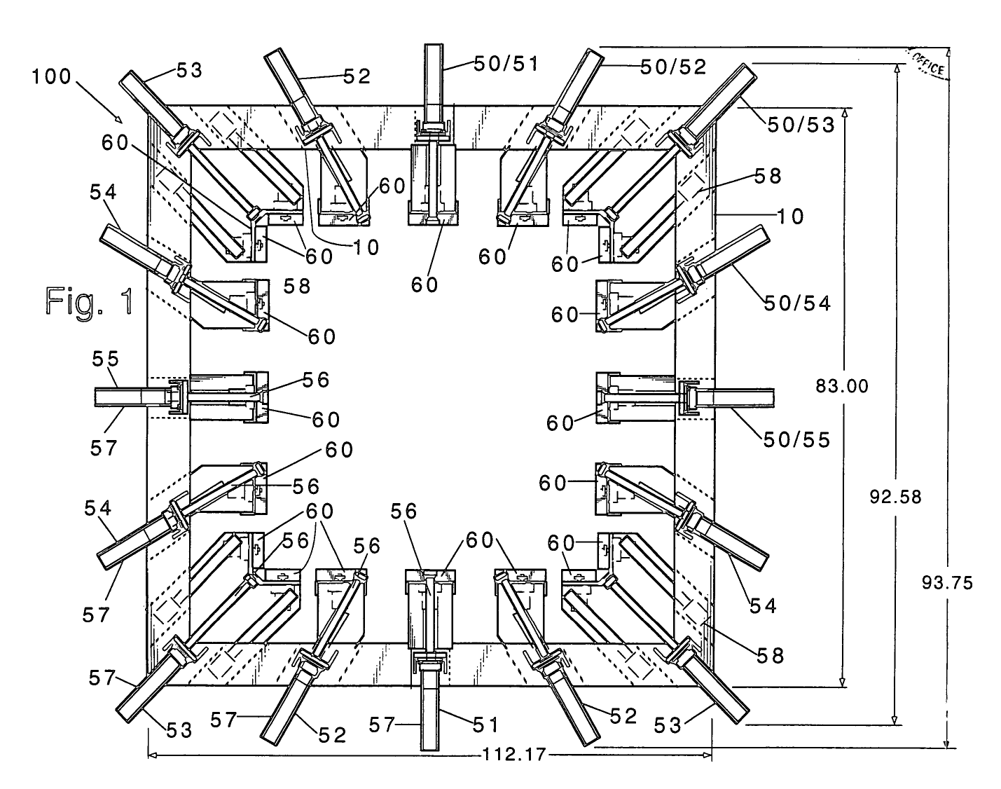

FIG. 1 is a top, plan view of an apparatus for formation of wide paint film parts of the invention, which includes a frame with grasper-retractors.

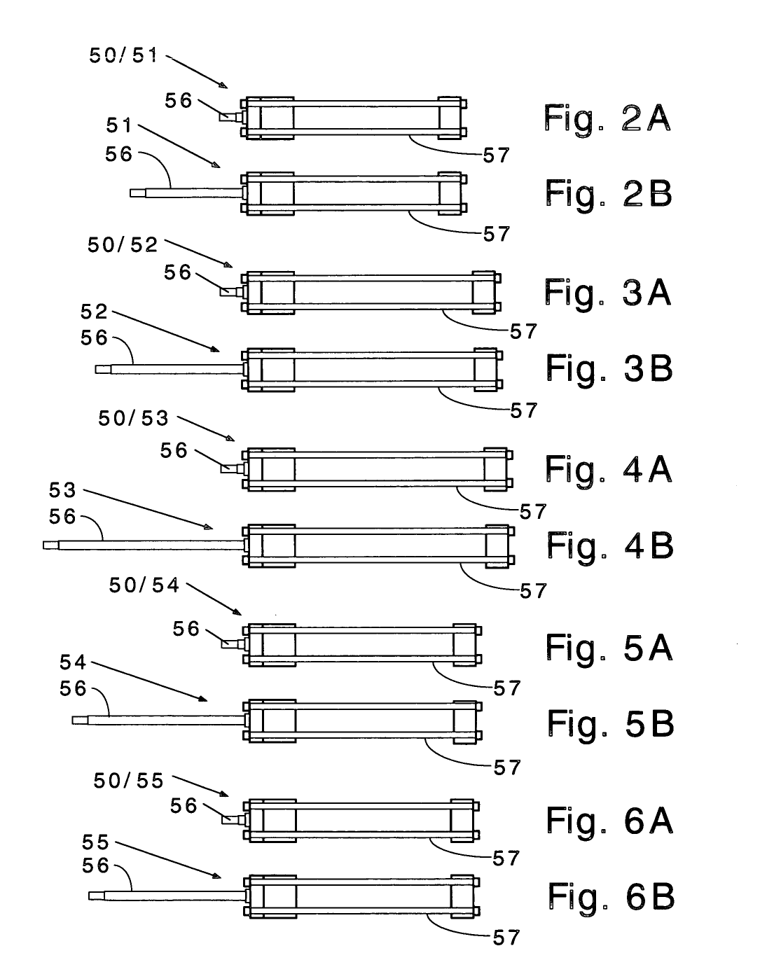

FIG. 2 shows an embodiment of an extender-retractor component for a grasper-retractor employed in the apparatus of FIG. 1, in a retracted position (A) and an extended position (B).

FIG. 3 shows another extender-retractor component for a grasper-retractor employed in the apparatus of FIG. 1, in a retracted position (A) and an extended position (B).

FIG. 4 shows another extender-retractor component for a grasper-retractor employed in the apparatus of FIG. 1, in a retracted position (A) and an extended position (B).

FIG. 5 shows another extender-retractor component for a grasper-retractor employed in the apparatus of FIG. 1, in a retracted position (A) and an extended position (B).

FIG. 6 shows another extender-retractor component for a grasper-retractor employed in the apparatus of FIG. 1, in a retracted position (A) and an extended position (B).

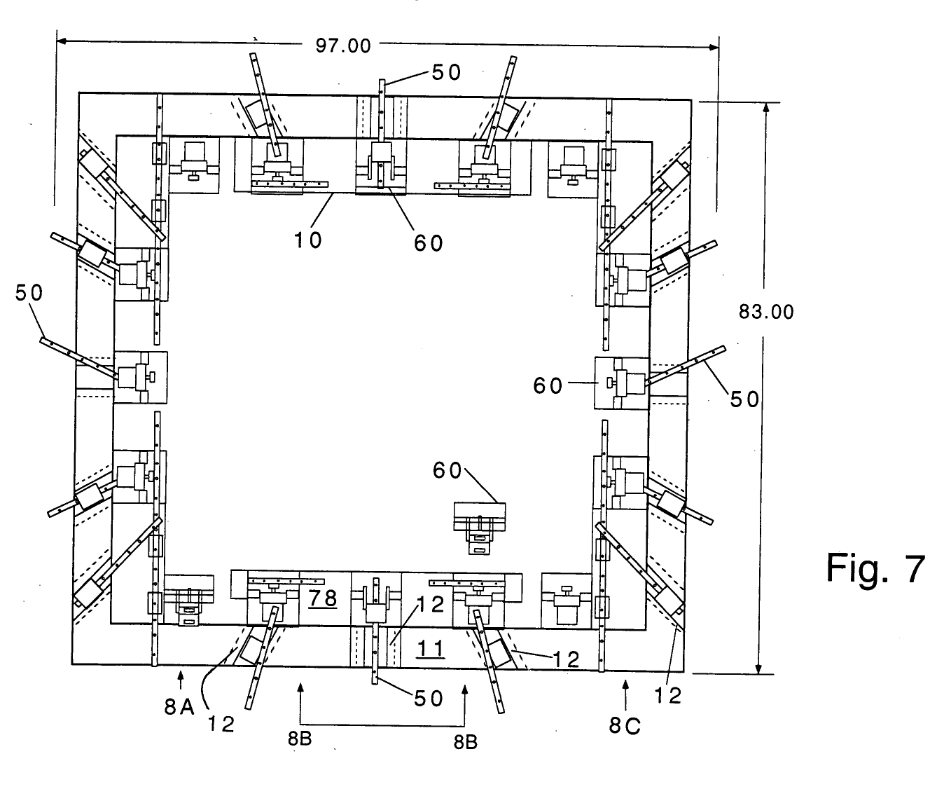

FIG. 7 is a top plan view of another apparatus for formation of wide paint film parts of the invention, which includes a frame and grasper-retractors. Compare, FIG. 1.

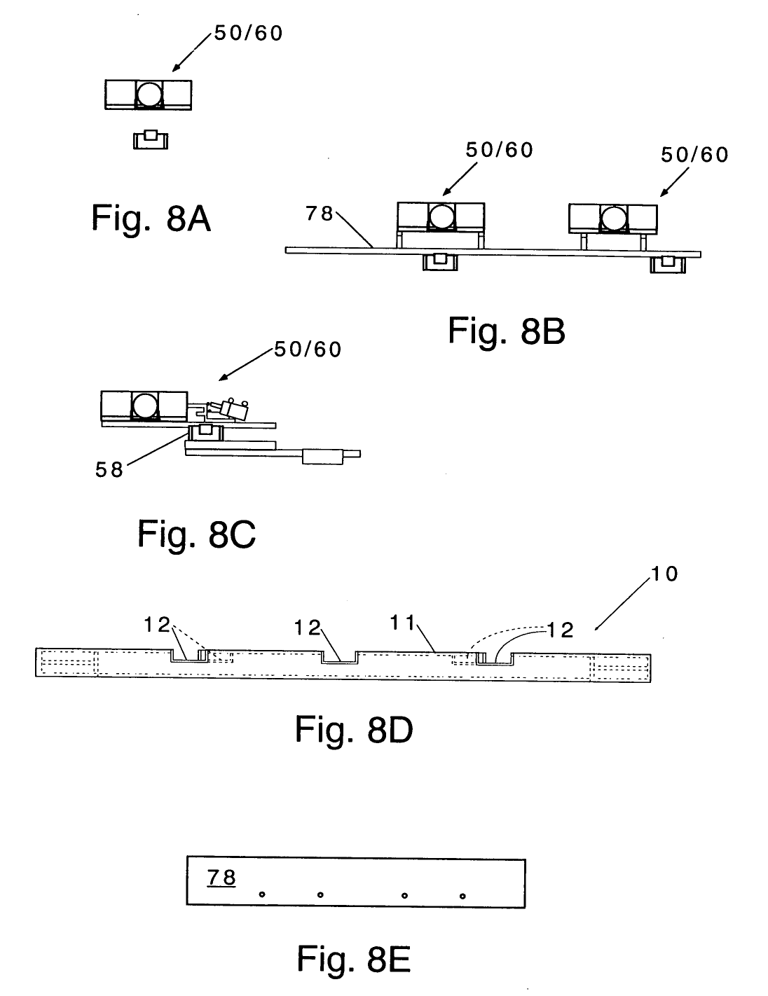

FIG. 8 shows views of parts of the apparatus of FIG. 7, which in general are employed as well in the apparatus of FIG. 1, to wit, an exploded, rear plan view of a grasper-retractor (A) taken generally along arrow 8A in FIG. 7; a set of grasper-retractors (B) taken along arrow 8B in FIG. 7; another grasper-retractor (C) taken along arrow 8C in FIG. 7; a side, elevational plan view of a frame member on or in which the foregoing grasper-retractors may be associated (D); and a top plan view of a part shown in FIG. 8B (E).

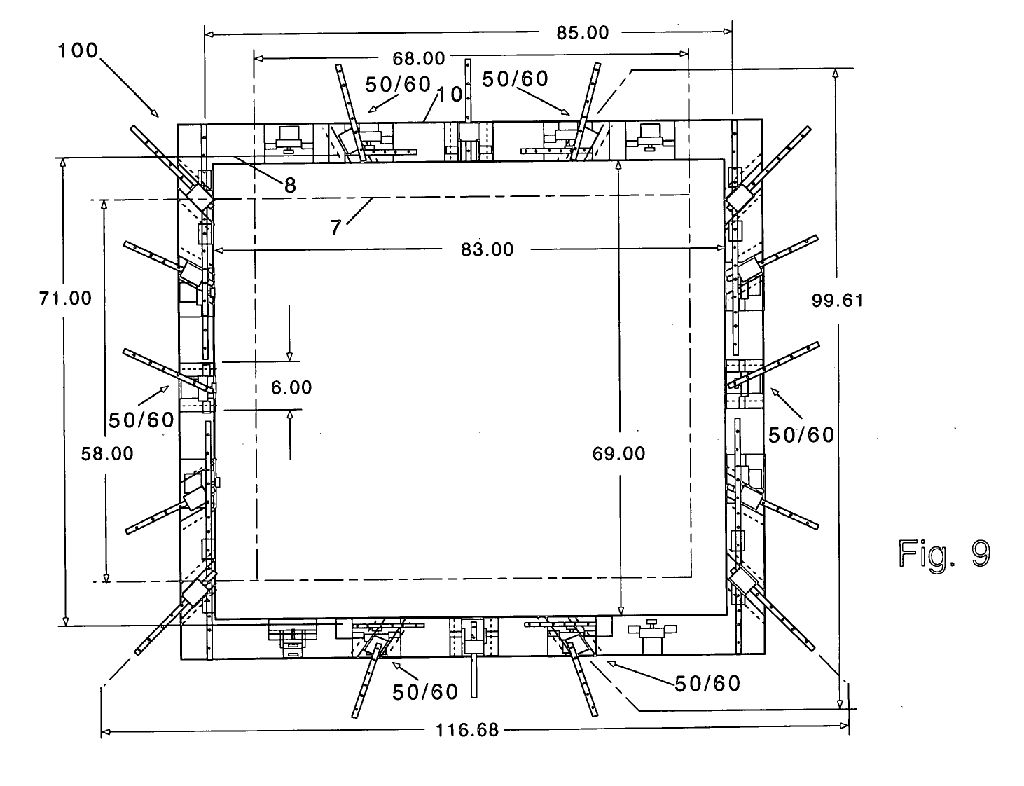

FIG. 9 is a top plan view of another apparatus for formation of wide paint film parts of the invention, which includes a frame and grasper-retractors. Compare, FIGS. 1, 8.

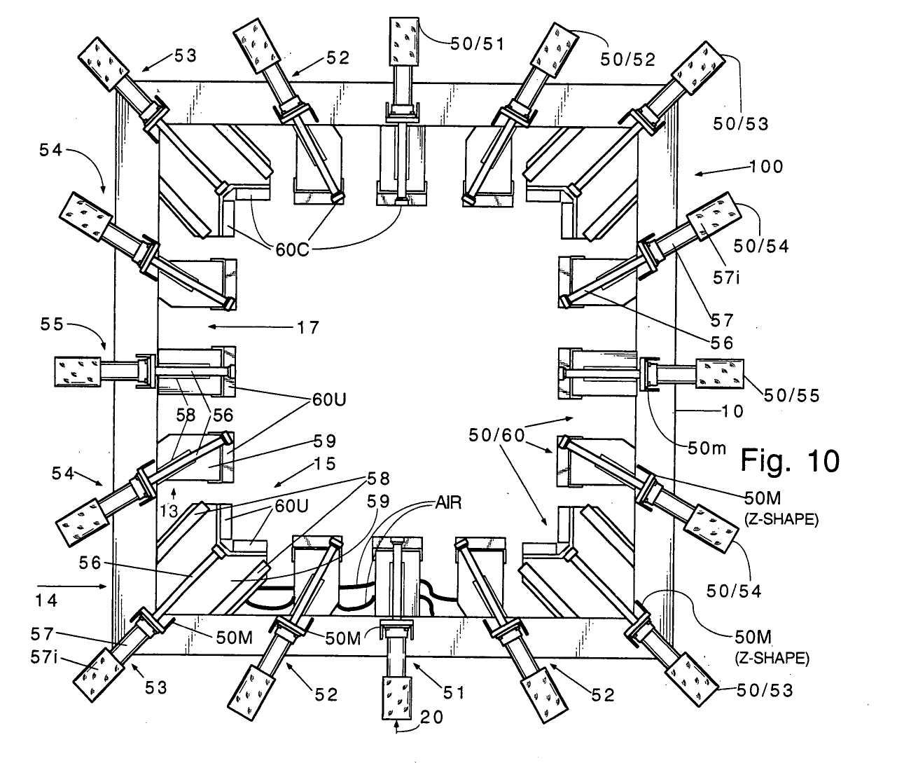

FIG. 10 is a top view of another apparatus for formation of wide paint film parts of the invention, which includes a frame and pneumatic grasper-retractors, with some air lines and all electrical lines not depicted. Compare, FIGS. 1, 8, 9.

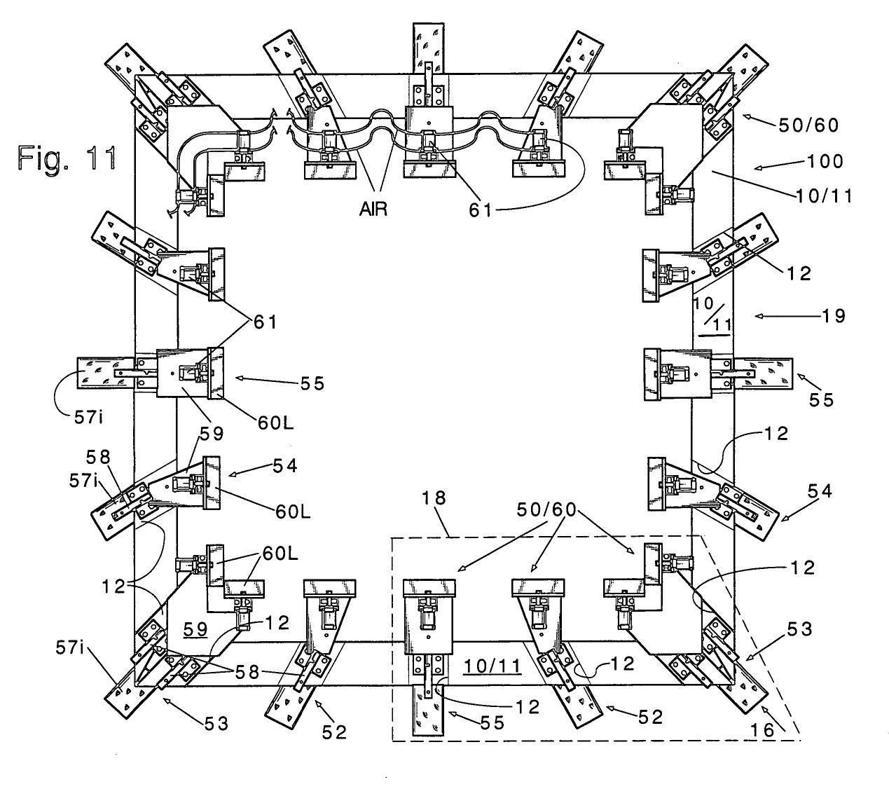

FIG. 11 is a bottom view of the apparatus of FIG. 10.

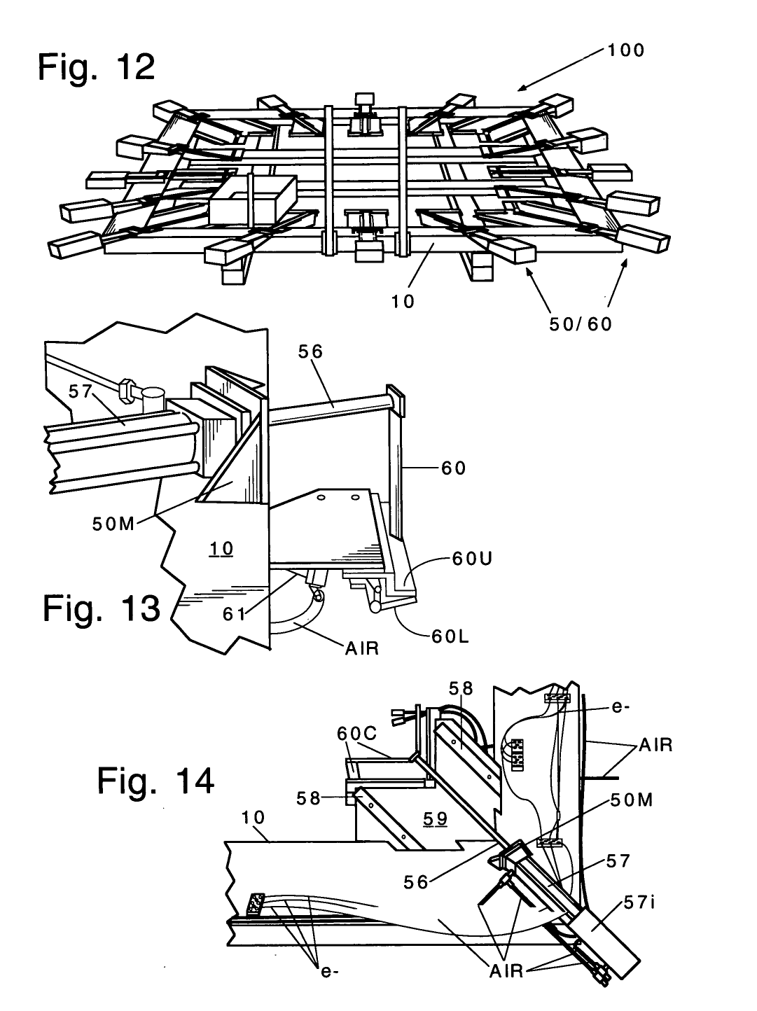

FIG. 12 is a top, perspective view of the apparatus of FIG. 10 (strapped to a frame for transport).

FIG. 13 is a top, perspective view of an oblique grasper-retractor assembly mounted to the frame, taken generally along arrow 13 in FIG. 10.

FIG. 14 is a top, perspective view of a corner grasper-retractor assembly mounted to the frame, taken generally along arrow 14 in FIG. 10.

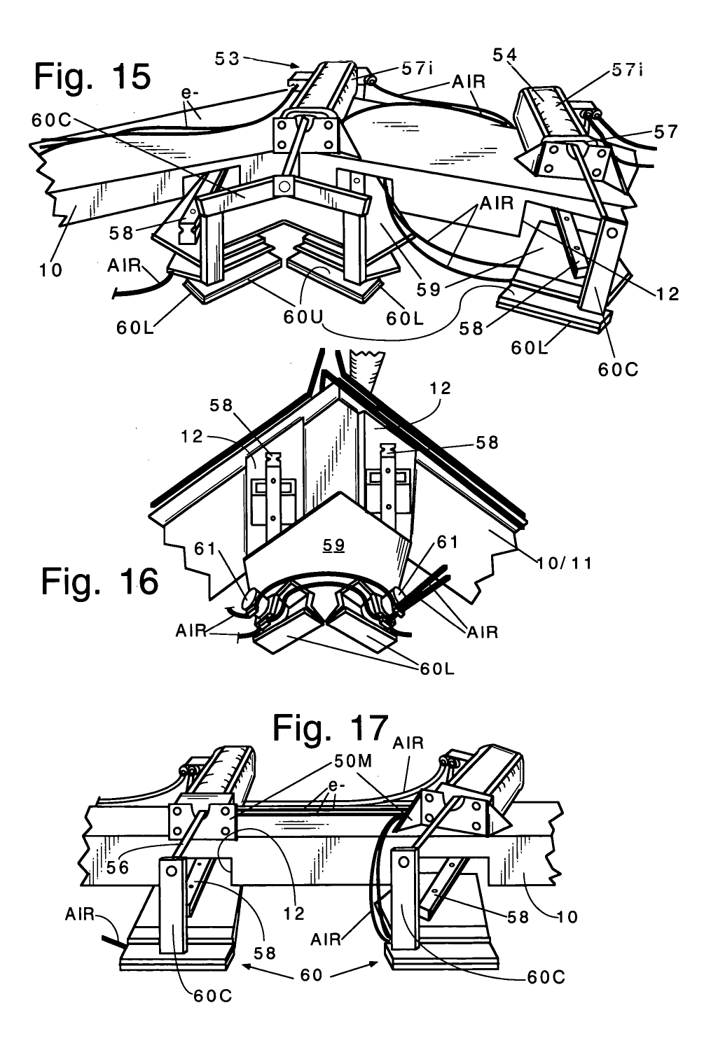

FIG. 15 is a top, perspective view of the mounted grasper-retractor assemblies of FIGS. 14 and 14, taken generally along arrow 15 in FIG. 10.

FIG. 16 is a bottom, perspective view of the mounted grasper-retractor assembly of FIG. 14, taken generally along arrow 16 in FIG. 11.

FIG. 17 is a top, perspective view of orthogonal and oblique grasper-retractor assemblies mounted to the frame, taken generally along arrow 17 in FIG. 10.

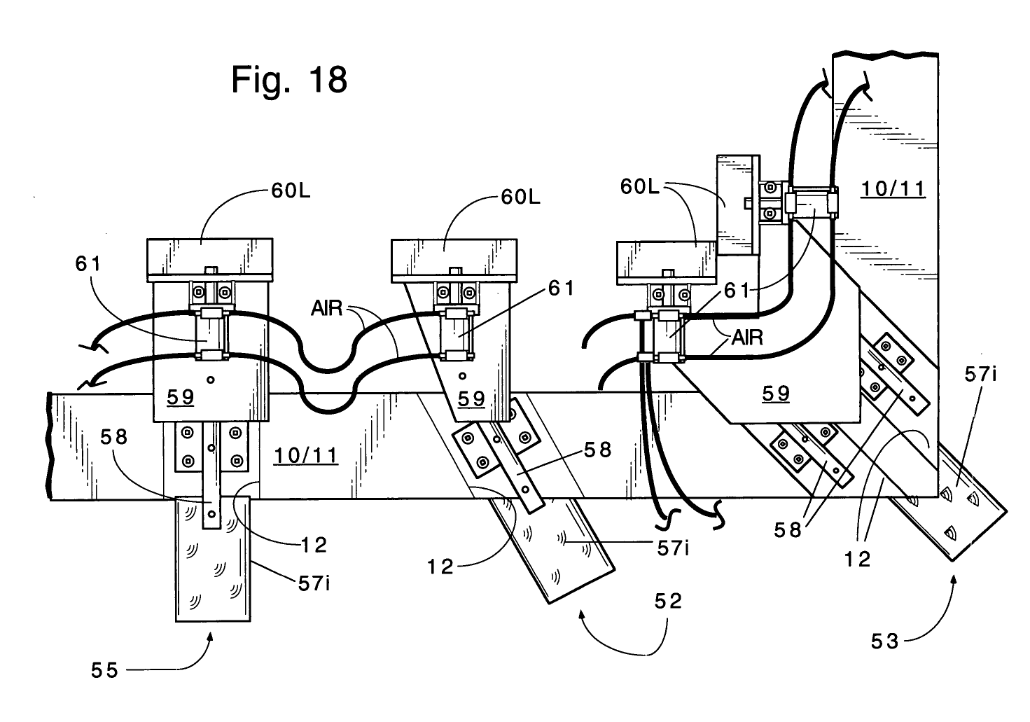

FIG. 18 is a bottom view in more detail of part of the apparatus of FIG. 10, taken generally in the loop 18 of FIG. 11.

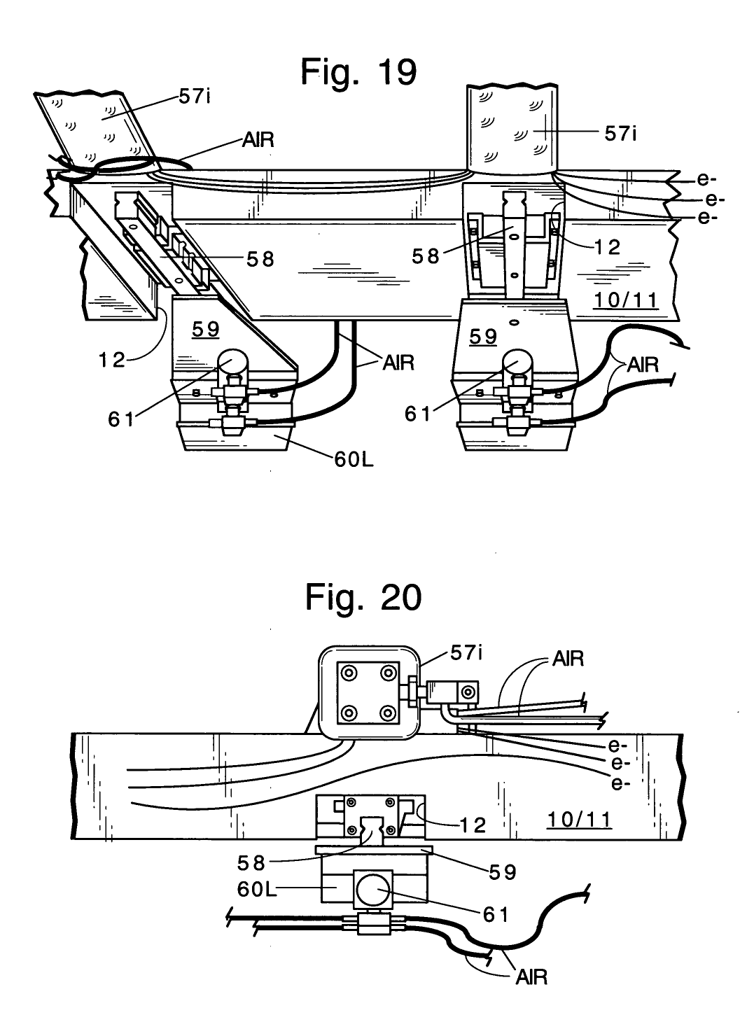

FIG. 19 is a bottom, perspective view of the mounted orthogonal and oblique grasper-retractor assemblies of FIG. 17, taken along arrow 19 in FIG. 11.

FIG. 20 is a side view of a mounted orthogonal grasper-retractor assembly, taken along arrow 20 of FIG. 10.

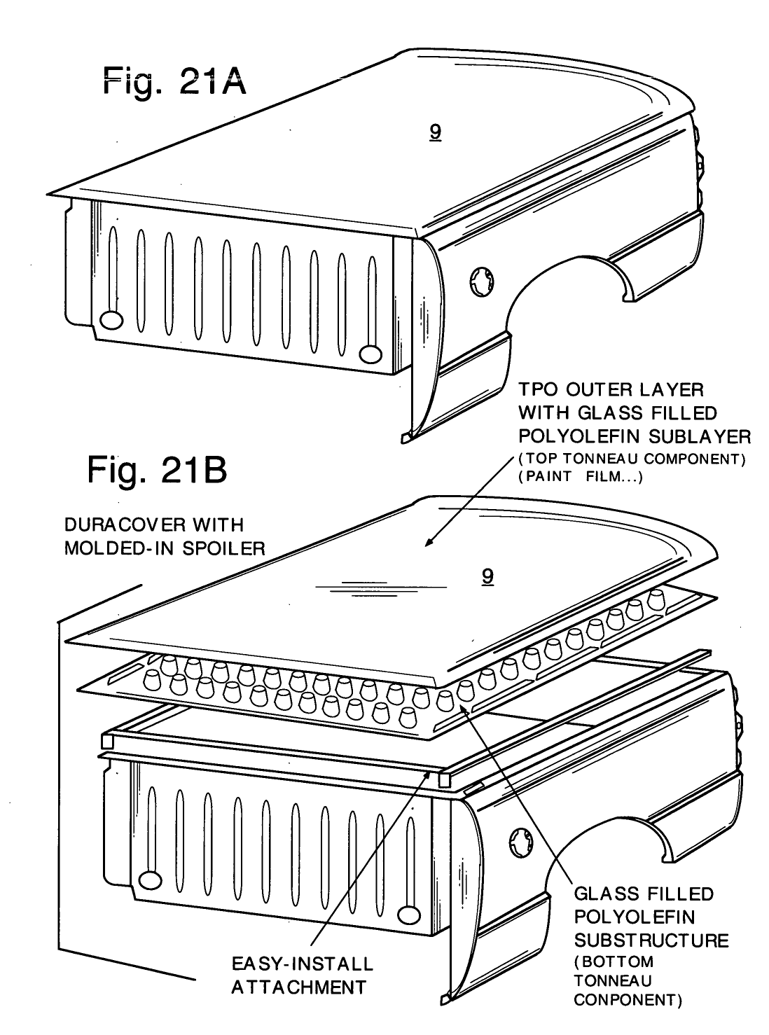

FIG. 21 shows perspective views of a wide paint film stock part product of the invention, a tonneau cover, associated with a box of a pickup truck, assembled (A); and exploded (B).

The invention can be further understood by the following detail, which may be read in view of the drawings. Such is to be taken in an illustrative and not necessarily limiting sense.

With respect to the drawings, apparatus 100 can be employed to grasp deformable paint film stock 7, which may be the starting material, for formation of wide paint film parts 8, 9. The part 8 is a drawn or stretched paint film stock precursor such as a paint film stock piece 7 lengthened and/or widened to exceed the original dimensions of the piece 7 when it is inserted into the apparatus 100 for formation. For example, when a paint film stock piece 7 is employed with a 58-inch width as the starting material and is drawn or stretched, the part 8 exceeds an about 60-inch width, to include exceeding of an about 65-inch, an about 70-inch, an about 75-inch, and an about 80-inch width; such a paint film stock piece 7 may have start with, for example, a 68-inch length, and be drawn or stretched to exceed an about 70-inch length, to include an about 75-inch, an about 80-inch, an about 85-inch, an about 90-inch, and an about 95-inch length, to form the part 8. Preferably, the part 8 is drawn or stretched in at least two non-parallel directions, for example, with standard rectangular or square starting stock along both its width and length. In terms of percentages, such drawing or stretching can be, for example, with respect to the dimension termed the width, at least about 103% (60/58); to include at least about 112% (65/58); 121% (70/58); 129% (75/58) and 138% (80/58); and with respect to the dimension termed the length, at least about 103% (70/68); to include at least about 110% (75/68); 118% (80/68); 125% (85/68); 132% (90/68) and 140% (95/68). In general, the drawing or stretching to form the precursor part 8 can result in a part 8 (or 9) which is at least about 103% of the size of the starting paint film piece, to include at least about 105%, 110%, 120%, 130%, 140%, and even 150% or greater, say, to about 400% or possibly more. The maximum amounts of drawing or stretching are typically limited by the properties of the deformable paint film stock, especially as concerns its paint film layer; with greater drawing or stretching often come risks of making the paint layer too thin, which can form a product less desirable in appearance. However, the part 9 is a formed wide paint film stock part, which may be formed from a precursor part 8, say, which may be cooled and/or formed on another production line or site, or be taken from starting paint film stock to the formed part 9 without processing interruption. Intricate molding features and so forth can be characteristic of the formed part 9. An example of the formed part 9 is a tonneau cover for a pickup truck, which, for instance, may have an overall width of about from sixty to seventy-six inches, an overall length of about from sixty to ninety-six inches, and other features such as curved sides, rolls and so forth. Note, FIGS. 21A and 21B. Other examples of formed parts 9 may include load floors, claddings, facias and so forth. Characteristically, the wide paint film parts 8 and 9 retain a painted surface finish from the starting paint film stock over substantially if not completely all of its visible final surface.

The apparatus 100 includes frame 10, which can include lateral support 11, and slide or glide grooves 12. See, FIGS. 1-20.

Attached to the frame 10 are at least two paint film stock grasping members 50/60. Preferably, at least two sets of the members 50/60 are present. Sets of the members 50/60 typically oppose one another in pairs. Preferably, the sets of members 50/60 draw or stretch the stock 7 (or part 8) along at least two axes, and, desirably at least two of these axes are substantially orthogonal to one another. Each member 50/60 can grasp the deformable paint film stock 7, and, beneficially, opposing members 50/60 can be moved apart from one another upon grasping of the stock 7 (or part 8 as the case may be). A member 50/60 may include extender-retractor component 50 mounted to the frame 10 through mount 50M, which advantageously can be a highly stable in a Z-shape, such as the variously sized extender-retractors 51, 52, 53, 54 and 55, each of which may have extending-retracting arm 56 and housing 57, for example, which may be pneumatically activated such as by a piston (pitman) and cylinder arrangement. The housing 57 may be thermally insulated with insulation 57i, say, of glass fiber having a metal foil outer skin. With respect to lateral support member(s) 11 of the frame 10, which may be in a rectangular or square shape overall, the extender-retractors 50 may be of orthogonal 51, 55; oblique 52, 54; and/or corner 53 type. In a typical assembly 100, the extender-retractors 50 are actuated in the same plane with one another, which advantageously is, in general, parallel with a plane formed by the lateral support portions 11 of the frame 10. Hydraulic and/or mechanical activation as by screws, gears and so forth may be employed. Auxiliary guides 58 may be provided, for example, one per orthogonal or oblique arm 51, 52, 54, 55 or in corners of the frame 10, say, with two guides 58 assisting one subassembly 53, which may extend into and slide within a corresponding slide or groove 12 of a lateral support 11 of the frame 10. Plate 59 may connect the guide(s) 58 with stock/part-grasping clamp 60 through upstanding connecting member 60C. The member 50/60 can grasp the stock 7, or part 8, through the clamp 60, which can have a set of jaws, which can include lower jaw 60L and upper jaw 60U, with at least one of these movable in relation to the other, say, with the lower jaw 60L movable with respect to a stationary upper jaw 60U, for example, each made of a flat metal plate and endowed to close and open pneumatically through extension-retraction cylinders 61 typically smaller than the extender-retractors 51, 52, 53, 54, 55. Here, too, hydraulic and/or mechanical activation as by screws, gears and so forth may be employed. The clamp 60, which is attached to a corresponding arm 56 of a grasper-retractor 51-55 can be drawn away from its opposing counterpart through retraction of opposing sets of the grasper-retractors 51-55, and which grasps the stock 7, or the part 8, in order to move opposing sets of such members apart to draw or stretch the stock 7, or the part 8. See, FIGS. 1-20. A grasper-retractor 50/60 may find a substitute in a nonretractable clamp, from which an opposing, movable grasper-retractor 50/60 would pull in order to draw or stretch stock 7 or parts 8.

As would be understood by persons skilled in the art, the frame 10 and stock grasping member 50/60 ensemble can include member 78, and additional features such as stops, limit switches, guards, and so forth. Electrical wiring (e-) may be insulated with glass fiber insulated to withstand heat as well. Auxiliary equipment and structures can be provided. For example, a vacuum device can be employed to grasp a sheet of the stock 7, or part 8, for delivery to the apparatus 100; stock heaters, for example, ceramic heaters, are typically employed to heat the stock 7, or part 8, for formation of the next part 8 or 9 in the series; the apparatus 100 may be conveyed through a stock-processing oven to do this; and post-processing equipment such as a conveyancing contrivances and/or a cooler may be employed.

The apparatus 100 and its parts can be made with suitable materials. For example, metal parts are advantageously employed for the most part, to include for the frame 10, much if not all of the grasper-retractors 50/60, pneumatic lines (air) and so forth. Methods known to those skilled in the pertinent art can be employed to make and assemble the apparatus 100 and its parts.

In typical practice of the wide paint film part formation methodology of the invention, the apparatus 100 and deformable paint film stock, as starting stock 7 or part 8 are provided. The stock 7, 8 is fed into place with the assistance of loading tables and the vacuum device, and grasped on generally opposing sides by at least two sets of the paint film stock grasping members 50/60, say, with the jaws of the clamps 60 by closure of a movable lower jaw plate against a stationary upper jaw plate. While the stock 7, 8 is so grasped, it is moved apart by the at least two sets of members 50 (51-55) so as to draw or stretch the stock. Heating by heaters is typically carried out to soften the stock 7, 8 for the step of drawing or stretching. Following the latter, the part 8 or 9 is moved along with the post-processing equipment 90. An advantageous thermoformer sequence of operation in the practice of the invention is set forth as follows:
A. Sheet 7 is loaded into grasper-retractor subassemblies 50/60 by vacuum cups, load table, and/or other means.
B. The loaded frame 10 is moved into an oven.
C. Upon completion of heat-up, the loaded frame is moved from the oven and into a forming area over or under a mold, depending upon whether the mold is mounted to top or bottom plateau.
D. Cylinders 57 of the extender-retractors 51, 52, 53, 54 and 55 are energized to retract and stretch the sheet 7 to proper size, forming a hot precursor part 8.
E. Mold is moved into position to form part 9 from part 8.
F. Cycle is completed per standard thermoforming methods.
G. After the part 9 is unloaded, the cylinders 57 are energized to extend to enable loading of new sheet 7, and the sequence is repeated.
   Temperatures, times, and other parameters can vary, particularly according to properties of the stock 7 or part 8 employed or part 8, 9 made, as would be understood by persons skilled in the art.

The present invention is thus provided. Various features, parts, subcombinations or combinations may be employed with or without reference to other features, parts, subcombinations and combinations in the practice of the invention, and numerous modifications can be effected within its spirit, the literal claim scope of which is particularly pointed out as follows:

1-9. (Canceled)

10. A method for forming wide paint film parts, which comprises:
providing apparatus for forming wide paint film parts, having a frame; and, attached to the frame, at least two paint film stock grasping members, which generally oppose one another, which can grasp deformable paint film stock, at least one of which can be moved apart from the other while the stock is grasped;
providing a deformable paint film stock;
grasping the stock on generally opposing sides by at least two paint film stock grasping members; and
moving, while the stock is so grasped, the at least one of the two paint film stock grasping members apart from the other so as to draw or stretch the stock.

11. The method of claim 10, wherein heat is applied to the stock to facilitate stretching.

12. The method of claim 10, wherein the stock is stretched to at least about 125% of at least one of its original dimensions before stretching.

13. Apparatus for forming wide paint film parts, comprising a frame; and, attached to the frame, at least three paint film stock grasping members, at least two of which generally oppose one another and can grasp deformable paint film stock, at least one of the at least two paint film stock grasping members that generally oppose one another can be moved apart from the other while the stock is grasped, and the remaining paint film stock grasping member can grasp the stock in a direction oblique from that which the at least two paint film stock grasping members can draw or stretch the stock.

14. The apparatus of claim 13, wherein the frame has lateral support members in a rectangular or square arrangement, and the grasping members include orthogonal, oblique and corner types.

15. The apparatus of claim 13, which is electrically controlled and/or pneumatically actuated.

16. An article of manufacture comprising a drawn or stretched paint film stock part precursor or a formed wide paint film stock part.

17. The article of claim 16, which is said precursor.

18. The article of claim 16, which is said part.

19. The article of claim 18, which is a tonneau cover from a pickup truck.
